(19) United States
(12) Patent Application Publication
(10) Pub. No.: US 2026/0052339 A1
(43) Pub. Date: Feb. 19, 2026

(54) HEAD MOUNTED DISPLAY DEVICE AND SPEAKER MODULE THEREOF

(71) Applicant: HTC Corporation, Taoyuan City (TW)

(72) Inventors: Sung Jen Wang, Taoyuan City (TW); Chien-Hung Lin, Taoyuan City (TW); Li-Hsun Chang, Taoyuan City (TW); Kuan-Ying Ou, Taoyuan City (TW)

(73) Assignee: HTC Corporation, Taoyuan City (TW)

(21) Appl. No.: 19/052,277

(22) Filed: Feb. 13, 2025

Related U.S. Application Data
(60) Provisional application No. 63/682,800, filed on Aug. 14, 2024.

(51) Int. Cl. H04R 1/28; H04R 1/02; H04R 1/10

(52) U.S. Cl. CPC H04R 1/2826; H04R 1/025; H04R 1/028; H04R 1/1008; H04R 1/1041; H04R 2499/15

(57) ABSTRACT

A head mounted display device and a speaker module thereof are provided. The speaker module includes a host and a speaker module. The speaker module is installed on the host. The speaker module includes a casing, a speaker unit, a tuning cover and a first shape memory alloy element. The casing has a chamber, a front sound outlet and a rear sound outlet. The speaker unit is disposed in the chamber and divides the chamber into a front chamber and a rear chamber. The front chamber is communicated with the front sound outlet. The rear chamber is communicated with the rear sound outlet. The tuning cover is disposed in the casing and is located in the rear chamber. The first shape memory alloy element is connected between the tuning cover and the casing, and is configured to move the tuning cover to cover or expose the rear sound outlet.

### CROSS-REFERENCE TO RELATED APPLICATION

This application claims the priority benefit of U.S. provisional application Ser. No. 63/682,800, filed on Aug. 14, 2024. The entirety of the above-mentioned patent application is hereby incorporated by reference herein and made a part of this specification.

### BACKGROUND

### Technical Field

The disclosure relates to a display device and a sound module thereof, and in particular relates to a head mounted display device and a speaker module thereof.

### Description of Related Art

With the rapid advancement of current technology, the types and functions of head mounted display devices are becoming increasingly diverse. When using a head mounted display device, in addition to improving the visual experience, sound effects are also one of the key factors that enhance the sense of immersion of the user. Therefore, a head mounted display device is often also equipped with a speaker module. When the speaker module adopts a closed rear chamber design, a louder volume may be provided. Active noise reduction technology may also be adopted, while preventing sound leakage to maintain privacy. On the other hand, when the speaker module adopts an open rear chamber design, the speaker may provide a wider sound field and better low-frequency performance. However, no matter which design of speaker module is chosen, it is impossible to take into account the advantages of the other design.

### SUMMARY

A head mounted display device and a speaker module thereof, which may improve the problem that a speaker module of a single design has relative disadvantages, are provided in the application.

The head mounted display device of the application includes a host and a speaker module. The speaker module is installed on the host. The speaker module includes a casing, a speaker unit, a tuning cover and a first shape memory alloy element. The casing has a chamber, a front sound outlet and a rear sound outlet. The speaker unit is disposed in the chamber and divides the chamber into a front chamber and a rear chamber. The front chamber is communicated with the front sound outlet. The rear chamber is communicated with the rear sound outlet. The tuning cover is disposed in the casing and is located in the rear chamber. The first shape memory alloy element is connected between the tuning cover and the casing, and is configured to move the tuning cover to cover or expose the rear sound outlet.

The speaker module of the application includes a casing, a speaker unit, a tuning cover and a first shape memory alloy element. The casing has a chamber, a front sound outlet and a rear sound outlet. The speaker unit is disposed in the chamber and divides the chamber into a front chamber and a rear chamber. The front chamber is communicated with the front sound outlet. The rear chamber is communicated with the rear sound outlet. The tuning cover is disposed in the casing and is located in the rear chamber. The first shape memory alloy element is connected between the tuning cover and the casing, and is configured to move the tuning cover to cover or expose the rear sound outlet.

Based on the above, in the head mounted display device and speaker module thereof of the application, the tuning cover may cover or expose the rear sound outlet, so that the user may switch according to requirements and get the desired sound effects in different scenarios.

### BRIEF DESCRIPTION OF THE DRAWINGS

FIG. 1 is a schematic diagram of a head mounted display device of an embodiment of the invention.

FIG. 2A is a cross-sectional schematic diagram of a speaker module of an embodiment of the invention.

FIG. 2B is a cross-sectional schematic diagram at the location of the rear sound outlet of the speaker module of FIG. 2A.

FIG. 3A is a cross-sectional schematic diagram of the speaker module of FIG. 2A in another state.

FIG. 3B is a cross-sectional schematic diagram at the location of the rear sound outlet of the speaker module of FIG. 3A.

FIG. 4A and FIG. 4B are cross-sectional schematic diagrams of a speaker module in two states of another embodiment of the invention.

FIG. 5 is a cross-sectional schematic diagram of a speaker module of yet another embodiment of the invention.

FIG. 6A and FIG. 6B are partial schematic diagrams of a speaker module in two states of yet another embodiment of the invention.

FIG. 7A and FIG. 7B are partial schematic diagrams of a speaker module in two states of yet another embodiment of the invention.

### DETAILED DESCRIPTION OF DISCLOSED EMBODIMENTS

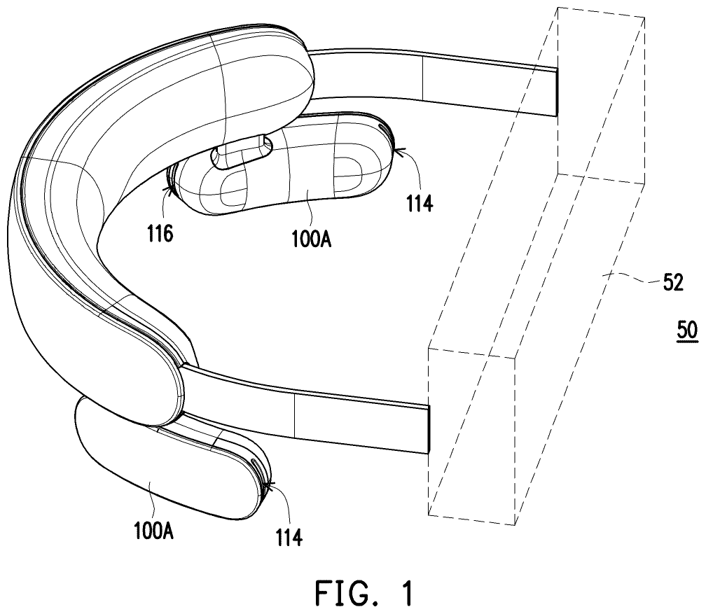

FIG. 1 is a schematic diagram of a head mounted display device of an embodiment of the invention. Referring to FIG. 1, the head mounted display device 50 of this embodiment includes a host 52 and a speaker module 100A. The speaker module 100A is installed on the host 52. In this embodiment, two speaker modules 100A are respectively installed on the left and right sides. However, it may be a single speaker module 100A or more speaker modules 100A, and the application is not limited thereto.

In this embodiment, the host 52 may be employed in fields such as a virtual reality system, an augmented reality system, or a mixed reality system. The host 52 may include components such as an optical system and a protective outer casing, and may be provided with or configured to accommodate a display. The aforementioned display may be a built-in display or an external portable display (e.g., a smartphone, etc.), but the application is not limited thereto. The optical system includes optical elements for changing the light path of the display, such as lenses, light guides or prisms. The host 52 in FIG. 1 is presented in a slightly larger form, but the host 52 may also be a lighter form or other forms.

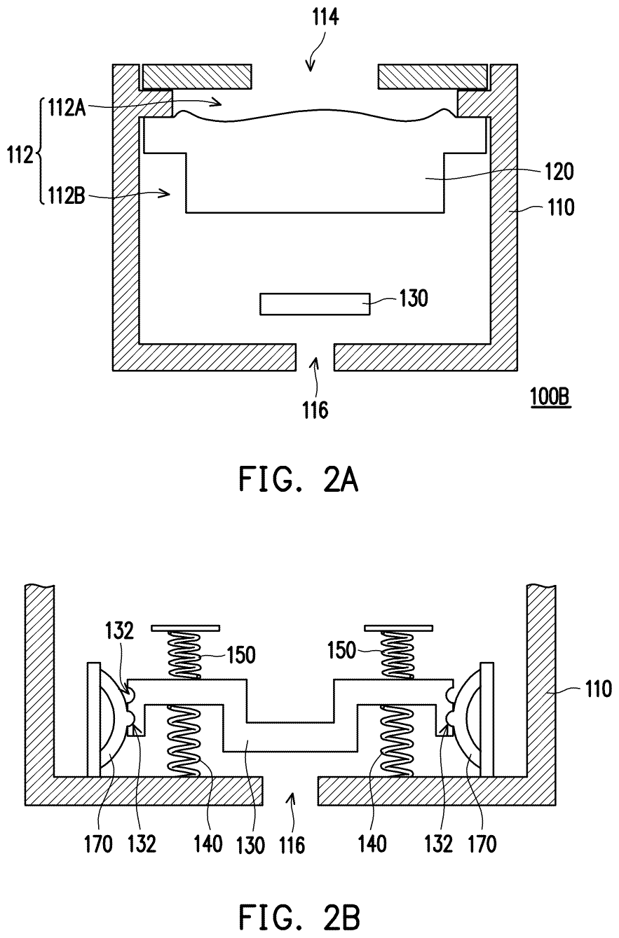

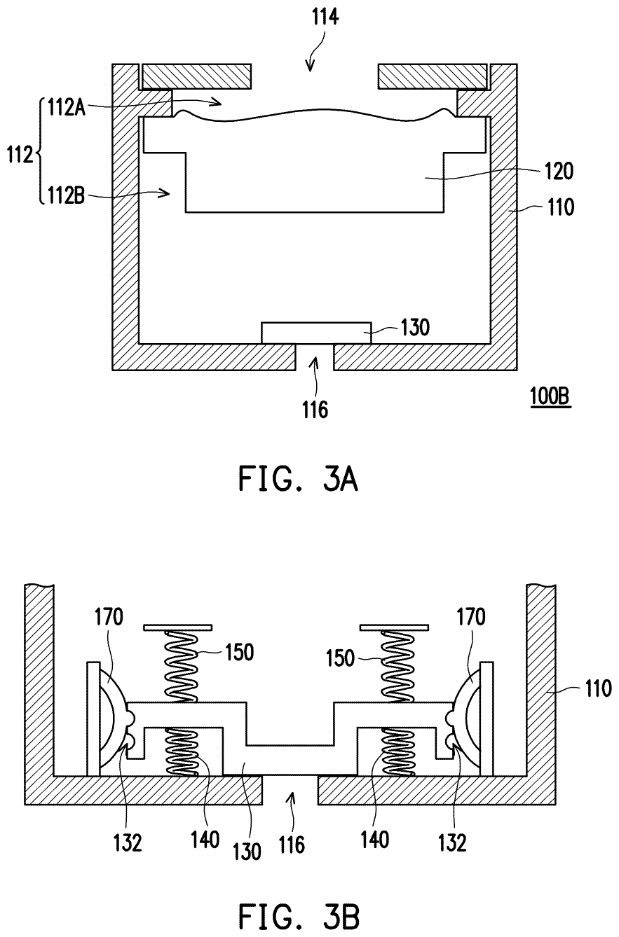

FIG. 2A is a cross-sectional schematic diagram of a speaker module of an embodiment of the invention. FIG. 2B is a cross-sectional schematic diagram at the location of the rear sound outlet of the speaker module of FIG. 2A. Referring to FIG. 2A and FIG. 2B, the appearance of the speaker module 100B of this embodiment is only for convenience of description. Its appearance may be adjusted according to requirements, for example, adjusted to have the appearance of the speaker module 100A as shown in FIG. 1, and this application is not limited thereto. Furthermore, the design of the speaker module 100B of this embodiment may be applied to the speaker module 100A of FIG. 1. In addition, FIG. 2A merely shows the position of the tuning cover 130, while the first shape memory alloy element 140 and other details are shown in FIG. 2B. The speaker module 100B of this embodiment includes a casing 110, a speaker unit 120, a tuning cover 130 and a first shape memory alloy element 140. The casing 110 has a chamber 112, a front sound outlet 114 and a rear sound outlet 116. The speaker unit 120 is disposed in the chamber 112 and divides the chamber 112 into a front chamber 112A and a rear chamber 112B. The speaker unit 120 usually has a single sound outlet direction, and the front sound outlet 114 is set as the sound outlet facing the sound outlet direction of the speaker unit 120. The front chamber 112A is communicated with the front sound outlet 114. The rear chamber 112B is communicated with the rear sound outlet 116.

The tuning cover 130 is disposed in the casing 110 and located in the rear chamber 112B. The first shape memory alloy element 140 is connected between the tuning cover 130 and the casing 110, and is configured to move the tuning cover 130 to cover or expose the rear sound outlet 116. In FIG. 2A and FIG. 2B, the tuning cover 130 keeps a distance from the rear sound outlet 116 and exposes the rear sound outlet 116. Therefore, the rear chamber 112B may communicate with the outside through the rear sound outlet 116. In this case, the speaker module 100 may provide the user with a wider sound field and better low-frequency performance. However, in noisy environments, it may experience insufficient volume output and is susceptible to interference from external sounds.

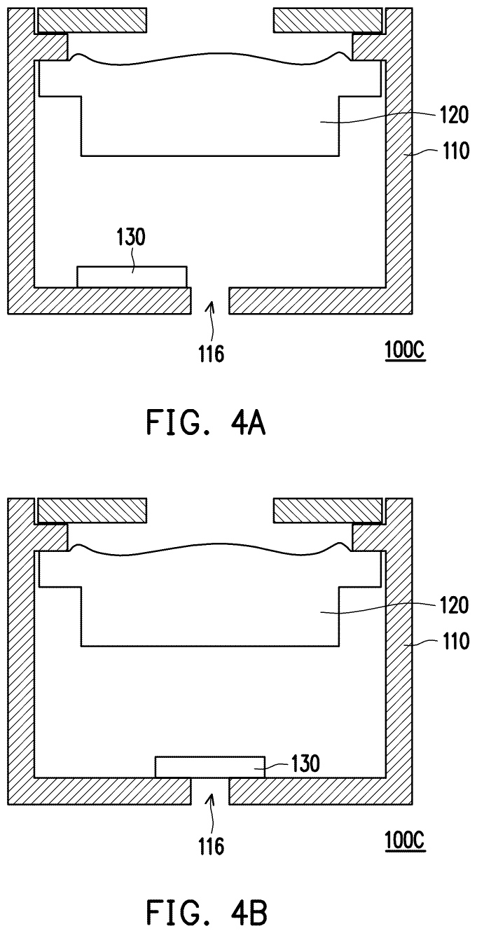

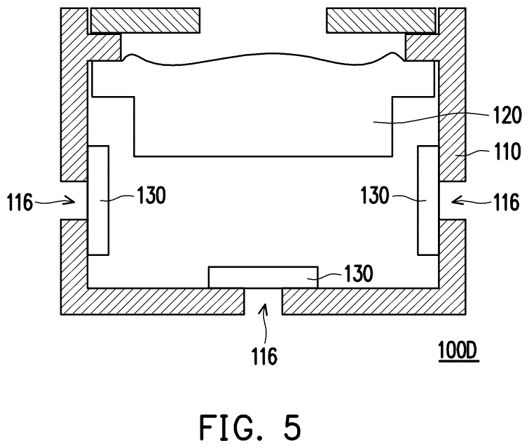

FIG. 3A is a cross-sectional schematic diagram of the speaker module of FIG. 2A in another state. FIG. 3B is a cross-sectional schematic diagram at the location of the rear sound outlet of the speaker module of FIG. 3A. Referring to FIG. 3A and FIG. 3B, at this time, the tuning cover 130 is in close proximity to the rear sound outlet 116 and covers the rear sound outlet 116. Therefore, the tuning cover 130 isolates the rear chamber 112B from the outside. In this case, the speaker module 100 may provide the user with a louder volume, is less susceptible to external sound interference, and prevents sound leakage, thereby offering enhanced privacy. Furthermore, in this case, active noise reduction may also be provided if the necessary components are available. However, the directionality of the sound field and the low-frequency performance are poor.

In the head mounted display device 50 and the speaker module 100 of this embodiment, the configuration of the first shape memory alloy element 140 and the tuning cover 130 allows the user to close or open the rear chamber 112B according to the requirements of the usage scenario. For example, when the user is in a noisy environment, the tuning cover 130 may be moved in an electronically controlled manner to cover the rear sound outlet 116 to reduce the interference of external noise. When the user wishes to listen to high-quality music or watch a movie in a relatively quiet environment, the first shape memory alloy element 140 may be electrically controlled to move the tuning cover 130 to expose the rear sound outlet 116, thereby obtaining a louder volume and a sound field with improved directionality.

Referring to FIG. 2B and FIG. 3B, in this embodiment, the speaker module 100 may further include a second shape memory alloy element 150 connected between the tuning cover 130 and the casing 110. The first shape memory alloy element 140 and the second shape memory alloy element 150 are respectively connected to two opposite sides of the tuning cover 130. For example, the first shape memory alloy element 140 and the second shape memory alloy element 150 are designed to contract when heated by electricity, but the application is not limited thereto. When the first shape memory alloy element 140 is electrified and heated, it begins to contract from the state of FIG. 2B to the state of FIG. 3B, and pulls the tuning cover 130 toward the rear sound outlet 116 to cover the rear sound outlet 116.

In this embodiment, the speaker module 100 may further include an elastic locking member 170 disposed in the casing 110 and located beside the tuning cover 130. The tuning cover 130 has multiple positioning slots 132. When the tuning cover 130 moves to a position covering the rear sound outlet 116, the elastic locking member 170 may be engaged in a corresponding positioning slot 132. At this time, even if power to the first shape memory alloy element 140 is cut off, the elastic locking member 170 may still maintain the position of the tuning cover 130. Therefore, even if the first shape memory alloy element 140 is not electrified, the position of the tuning cover 130 may be maintained fixed, thereby reducing energy consumption.

On the other hand, when the second shape memory alloy element 150 is electrified, it begins to contract from the state of FIG. 3B to the state of FIG. 2B, overcoming the engagement force between the elastic locking member 170 and the positioning slot 132, and pulling the tuning cover 130 away from the rear sound outlet 116 to expose the rear sound outlet 116. Likewise, when the tuning cover 130 moves to a position away from the rear sound outlet 116, the elastic locking member 170 may be engaged in another corresponding positioning slot 132. At this time, even if power to the second shape memory alloy element 150 is cut off, the elastic locking member 170 may still maintain the position of the tuning cover 130. Therefore, even if the second shape memory alloy element 150 is not electrified, the position of the tuning cover 130 may be maintained fixed, thereby reducing energy consumption. In addition, in this embodiment, two first shape memory alloy elements 140 and two second shape memory alloy elements 150 are adopted, but their number may be a single one or more, and the application is not limited thereto.

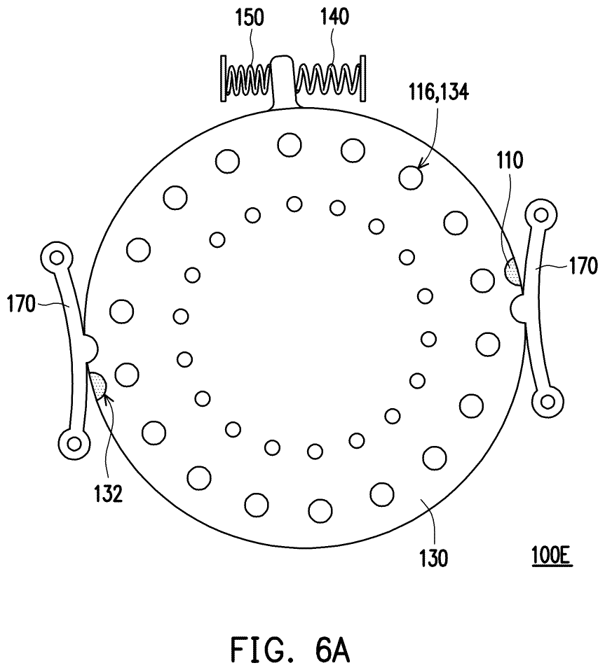

FIG. 4A and FIG. 4B are cross-sectional schematic diagrams of a speaker module in two states of another embodiment of the invention. In the embodiment of FIG. 2A and FIG. 3A, the first shape memory alloy element 140 is configured to translate the tuning cover 130, and the translation occurs in a direction perpendicular to the casing 110 where the rear sound outlet 116 is located. Referring to FIG. 4A and FIG. 4B, the speaker module 100C of this embodiment is similar to the speaker module 100B of FIG. 2A. The difference is that the tuning cover 130 of this embodiment translates in a direction parallel to the casing 110 where the rear sound outlet 116 is located. That is, the tuning cover 130 remains in a state flush with the casing 110, and moves to a position to cover or expose the rear sound outlet 116 as required. The tuning cover 130 may also be translated by employing the first shape memory alloy element 140 of FIG. 2B, and the second shape memory alloy element 150 and the elastic locking member 170 of FIG. 2B may also be selectively employed, and the description thereof is omitted here.

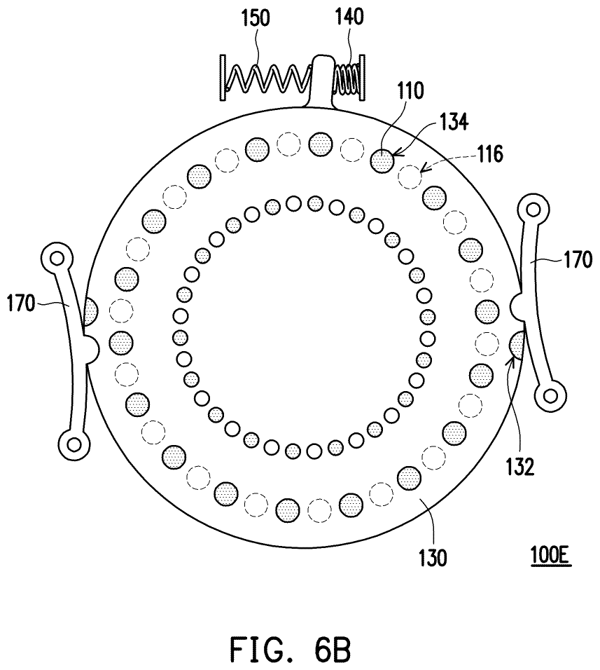

FIG. 5 is a cross-sectional schematic diagram of a speaker module of yet another embodiment of the invention. Referring to FIG. 5, the speaker module 100D of this embodiment is similar to the speaker module 100B of FIG. 2A. The difference is that the number of the tuning cover 130 and the corresponding rear sound outlet 116 of this embodiment is multiple. For example, in combination with a detector not shown, the position of the person with whom the user is talking may be detected. The tuning cover 130 is controlled to expose the rear sound outlet 116 facing the person with whom the user is talking, while closing other rear sound outlets 116, thereby directing the sound field towards the person with whom the user is talking. This configuration allows only the person with whom the user is talking to clearly hear the sound of the user, while surrounding individuals are unable to hear the sound or may only hear faint and indistinct sounds, thus enhancing the privacy of the conversation. On the other hand, the intensity distribution of the sound heard by the user may be controlled by exposing or closing the rear sound outlets 116 at different positions.

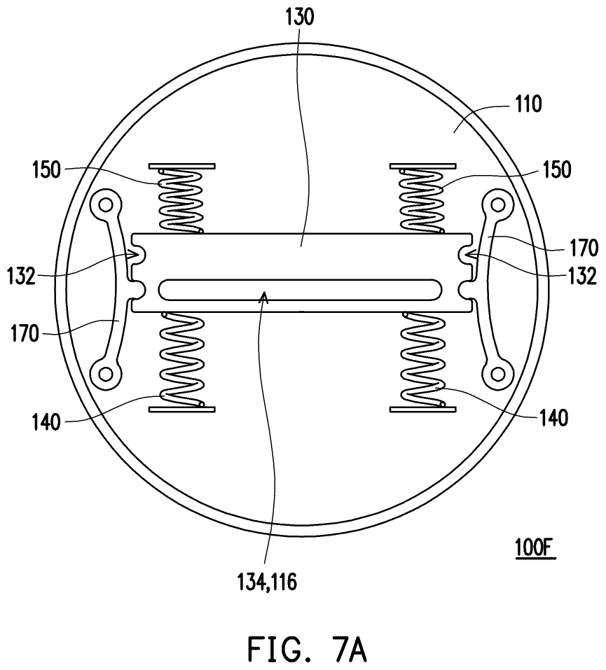

FIG. 6A and FIG. 6B are partial schematic diagrams of a speaker module in two states of yet another embodiment of the invention. Referring to FIG. 6A and FIG. 6B, which only show the structure of the speaker module 100E of this embodiment at the location of the tuning cover 130, with the remaining portions omitted. In this embodiment, the first shape memory alloy element 140 is configured to rotate the tuning cover 130. The tuning cover 130 has multiple openings 134. The casing 110 has multiple rear sound outlets 116. The length of the first shape memory alloy element 140 changes depending on being electrified or not. When the length of the first shape memory alloy element 140 changes, the tuning cover 130 is rotated so that the opening 134 is aligned with the rear sound outlet 116 as shown in FIG. 6A or is offset from the rear sound outlet 116 as shown in FIG. 6B. Therefore, the user may also cover or expose the rear sound outlet 116 according to the change of usage scenario.

When the first shape memory alloy element 140 is electrified and heated, it begins to contract from the state of FIG. 6A to the state of FIG. 6B, and the tuning cover 130 is rotated to cover the rear sound outlet 116. On the other hand, when the second shape memory alloy element 150 is electrified, it begins to contract from the state of FIG. 6B to the state of FIG. 6A, and the tuning cover 130 is rotated to expose the rear sound outlet 116.

For example, the first shape memory alloy element 140 adopts a design that contracts when electricity is supplied, but the application is not limited thereto. In the state of FIG. 6A, the first shape memory alloy element 140 is not electrified. The orientation of the tuning cover 130 may be maintained and arbitrary rotation may be prevented because the elastic locking member 170 is engaged in a corresponding positioning slot 132. When the first shape memory alloy element 140 is electrified, it begins to contract from the state of FIG. 6A to the state of FIG. 6B, and the tuning cover 130 is rotated to cover the rear sound outlet 116.

When the tuning cover 130 rotates to a position covering the rear sound outlet 116, the elastic locking member 170 may be engaged in another corresponding positioning slot 132. Therefore, the elastic locking member 170 may still maintain the orientation of the tuning cover 130. When the second shape memory alloy element 150 is electrified, the contraction force of the second shape memory alloy element 150 may overcome the engagement force between the elastic locking member 170 and the positioning slot 132, and rotate the tuning cover 130 to the state shown in FIG. 6A to expose the rear sound outlet 116.

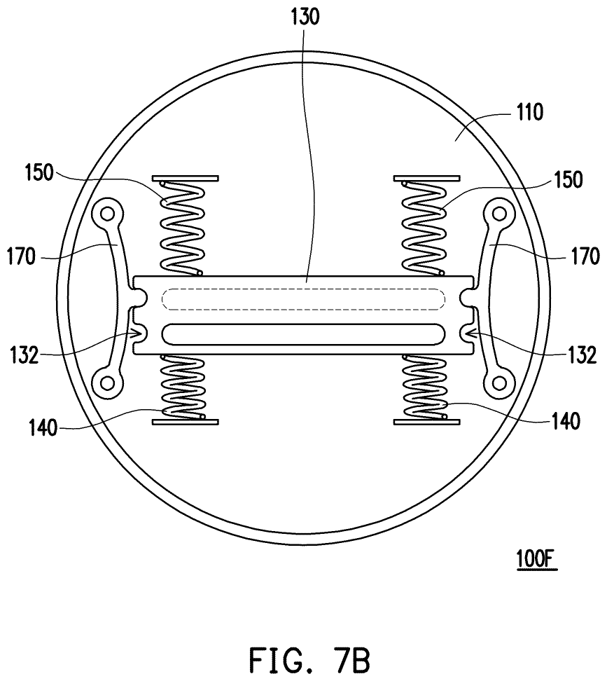

FIG. 7A and FIG. 7B are partial schematic diagrams of a speaker module in two states of yet another embodiment of the invention. Referring to FIG. 7A and FIG. 7B, which only show the structure of the speaker module 100F at the location of this embodiment at the tuning cover 130, with the remaining portions omitted. In this embodiment, the first shape memory alloy element 140 and the second shape memory alloy element 150 are configured to translate the tuning cover 130. The actions of the first shape memory alloy element 140, the second shape memory alloy element 150 and the elastic locking member 170 are substantially the same as those of the above-mentioned embodiments. The tuning cover 130 has an opening 134. When the first shape memory alloy element 140 is electrified and heated, it begins to contract from the state of FIG. 7A to the state of FIG. 7B, and pulls the tuning cover 130 downward in the figure, so that the opening 134 is misaligned with the rear sound outlet 116 as shown in FIG. 7B. On the other hand, when the second shape memory alloy element 150 is electrified, it begins to contract from the state of FIG. 7B to the state of FIG. 7A, overcoming the engagement force between the elastic locking member 170 and the positioning slot 132, and pulling the tuning cover 130 upward in the figure, so that the opening 134 is aligned with the rear sound outlet 116 as shown in FIG. 7A. Therefore, the user may also cover or expose the rear sound outlet 116 according to the change of usage scenario.

In summary, in the head mounted display device and speaker module thereof of the application, the covering or exposure of the rear sound outlet may be performed by moving the tuning cover using a shape memory alloy element, which has the convenience and precision of electrical control. This enables users to easily switch according to their requirements and get the desired sound effects in different scenarios. Moreover, this adjustment mechanism is characterized by its minimal size and weight.

What is claimed is:

1. A head mounted display device, comprising:
a host;
a speaker module, installed on the host, wherein the speaker module comprises:
a casing, having a chamber, a front sound outlet and a rear sound outlet;
a speaker unit, disposed in the chamber and dividing the chamber into a front chamber and a rear chamber, wherein the front chamber is communicated with the front sound outlet, the rear chamber is communicated with the rear sound outlet;
a tuning cover, disposed in the casing and is located in the rear chamber; and
a first shape memory alloy element, connected between the tuning cover and the casing, and configured to move the tuning cover to cover or expose the rear sound outlet.

2. The head mounted display device according to claim 1, wherein the speaker module further comprises a second shape memory alloy element connected between the tuning cover and the casing, wherein the first shape memory alloy element and the second shape memory alloy element are respectively connected to two opposite sides of the tuning cover.

3. The head mounted display device according to claim 1, wherein the speaker module further comprises an elastic locking member, disposed in the casing and located beside the tuning cover, wherein the tuning cover has a plurality of positioning slots, the elastic locking member is configured to be engaged in one of the positioning slots when the first shape memory alloy element is in a power-off state to maintain a position of the tuning cover.

4. The head mounted display device according to claim 1, wherein the first shape memory alloy element is configured to translate the tuning cover.

5. The head mounted display device according to claim 1, wherein the first shape memory alloy element is configured to rotate the tuning cover.

6. The head mounted display device according to claim 1, wherein the tuning cover has an opening, the first shape memory alloy element is configured to move the tuning cover so that the opening is aligned with the rear sound outlet or is misaligned with the rear sound outlet.

7. A speaker module, comprising:
a casing, having a chamber, a front sound outlet and a rear sound outlet;
a speaker unit, disposed in the chamber and dividing the chamber into a front chamber and a rear chamber, wherein the front chamber is communicated with the front sound outlet, the rear chamber is communicated with the rear sound outlet;
a tuning cover, disposed in the casing and is located in the rear chamber; and
a first shape memory alloy element, connected between the tuning cover and the casing, and configured to move the tuning cover to cover or expose the rear sound outlet.

8. The speaker module according to claim 7, further comprising a second shape memory alloy element connected between the tuning cover and the casing, wherein the first shape memory alloy element and the second shape memory alloy element are respectively connected to two opposite sides of the tuning cover.

9. The speaker module according to claim 7, further comprising an elastic locking member, disposed in the casing and located beside the tuning cover, wherein the tuning cover has a plurality of positioning slots, the elastic locking member is configured to be engaged in one of the positioning slots when the first shape memory alloy element is in a power-off state to maintain a position of the tuning cover.

10. The speaker module according to claim 7, wherein the first shape memory alloy element is configured to translate the tuning cover.

11. The speaker module according to claim 7, wherein the first shape memory alloy element is configured to rotate the tuning cover.

12. The speaker module according to claim 7, wherein the tuning cover has an opening, the first shape memory alloy element is configured to move the tuning cover so that the opening is aligned with the rear sound outlet or is misaligned with the rear sound outlet.
